(19) United States
(12) Patent Application Publication
(10) Pub. No.: US 2025/0272771 A1
(43) Pub. Date: Aug. 28, 2025

(54) SYSTEM AND METHOD FOR RECOMMENDING ENVIRONMENTAL MATERIALS

(71) Applicant: Bahari Analytics Inc, Huntsville, AL (US)

(72) Inventor: Bharat Abna Khuti, Huntsville, AL (US)

(73) Assignee: Bahari Analytics Inc, Huntsville, AL (US)

(21) Appl. No.: 19/065,578

(22) Filed: Feb. 27, 2025

Related U.S. Application Data
(60) Provisional application No. 63/558,207, filed on Feb. 27, 2024.

(51) Int. Cl. G06Q 50/08; G06N 3/042; G06Q 10/0631

(52) U.S. Cl. CPC G06Q 50/08; G06N 3/042; G06Q 10/06313

(57) ABSTRACT

A system and method for recommending environmentally conscious materials for construction and manufacturing projects is disclosed. The system addresses the need for tools to identify materials that meet decarbonization goals and comply with climate disclosure rules. The system includes a data acquisition module, a data ingestion module, and a private generative AI large language model trained on a knowledge graph of material and chemical relationships. This system generates recommendations for alternative materials, calculates an Environmental Cost Indicator (ECI) and Ecoscore, and records data on a blockchain ledger. The primary use of the system is to provide decision support for selecting low-carbon materials, thereby reducing environmental impacts. Additionally, the system includes a user interface for exploring options and simulating impacts on ECI and Ecoscore. This system is particularly useful for investors, architects, and organizations aiming to achieve net-zero decarbonization goals.

### CROSS-REFERENCE TO RELATED APPLICATIONS

This application claims the benefit of U.S. Provisional Patent Application No. 63/558,207, filed Feb. 27, 2024, which is incorporated by reference herein in its entirety.

### BACKGROUND

The present disclosure relates to a private domain specific use of generative artificial intelligence, and more particularly, to a system and method for generating environmentally friendly recommendations for products and services.

Currently, jurisdictions are implementing goals and rules associated with decarbonization and climate disclosure. Investors, Banks, Governments, Organizations, Product designers and architects must find materials to meet these net-zero decarbonization goals and comply with climate disclosure rules. However, there are no current tools, analytics, decision support systems, or automated data sources that allow for rapid material searching and tracking to identify and reduce environmental impacts including carbon emissions.

As can be seen, there is a need for a system and method that can provide intelligent decision support for determining environmentally friendly materials during the design of a product or service that balance both the environmental impact and financial implications.

### SUMMARY OF THE INVENTION

In one embodiment, the disclosure includes a private and domain specific Generative AI system for identifying and recommending environmentally conscious alternative materials, components, energy, and parts for construction projects and manufactured products. The system comprises a data acquisition and profiling module for acquiring and analyzing data from at least one data source; a data ingestion and processing module for ingesting and processing the data; an active metadata repository for maintaining metadata associated with the data; a private and domain specific generative AI large language model (LLM) trained on a comprehensive knowledge graph of material and chemical relationships, including dependencies, and utilizing advanced vector-based reasoning; a recommendation generation engine powered by the LLM and knowledge graph for analyzing application requirements and identifying suitable alternatives; a generative AI driven carbon and environmental footprint calculator for calculating an Environmental Cost Indicator (ECI) and a weighted Ecoscore; a dependency registry and validation module for maintaining and validating dependencies identified by the LLM; and a human supervision and quality control module for applying rules pertaining to quality, security, and ethics.

The Generative AI system further comprises a continuous learning module configured to dynamically update and refresh the LLM and the knowledge graph based on changes in data sources and user interactions. Additionally, the system includes a user interface configured to enable a user to explore and select options within a dynamic knowledge graph, visualize options, present a ranked set of related alternatives, navigate the knowledge graph through user-driven filtering and exploration, and simulate the impact of options on the ECI and Ecoscore ratings.

The Generative AI system utilizes interactions and recommendations to retrain the LLM. The system may also include a blockchain module configured to record validated projects, products, emissions, and reductions on a blockchain ledger and generate a blockchain token. Furthermore, the system comprises a carbon offset identification module configured to identify carbon offset assets, match identified and validated carbon emissions to carbon offsets within a carbon exchange, and select an optimum carbon offset strategy.

In another embodiment, the disclosure includes a method for generating environmentally conscious alternatives for construction projects and products. The method comprises acquiring and processing external and internal data; training a private vectorized generative AI LLM on the processed data; generating recommendations for alternative materials and chemicals using the LLM; calculating a carbon and environmental footprint for a project or product; generating an ECI and a weighted Ecoscore based on the calculated footprint; presenting recommendations to a user; enabling a user to select and visualize options based on recommendations; simulating the impact of options on the ECI and Ecoscore; recording validated carbon emissions and reductions on a blockchain ledger; and identifying carbon offset assets based on validated emissions and reductions.

In a further embodiment, the disclosure includes a non-transitory computer-readable storage medium storing instructions that, when executed by a computer, cause the computer to perform the method for generating environmentally conscious alternatives. Additionally, the disclosure includes a non-transitory computer-readable medium storing a private and domain specific vectorized generative AI LLM trained on a dataset of environmental regulations, product information, and external databases, capable of generating recommendations for alternative materials and chemicals for construction projects and manufactured products. These and other features will be more clearly understood from the following detailed description taken in conjunction with the accompanying drawings and claims.

### BRIEF DESCRIPTION OF THE DRAWINGS

FIG. 1 is a method for Generative Artificial Intelligence recommendations, according to aspects of the present disclosure; and

FIG. 2 is a schematic diagram of a system for Generative Artificial Intelligence recommendations, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As stated above, there is no automated system and method for identifying and modeling environmental impacts, reductions and compliance goals with respect to a manufactured product design, service or construction project. Current methods are based on syntax search/fuzzy logic to find and match similar materials and their alternatives. This approach does not scale and is highly inaccurate, given the number of parameters that need to be profiled. Another technique makes use of supervised learning models to generate unique signatures and use signatures as a method of identifying similar materials and chemicals. Again, due to the number of parameters to be trained, supervised learning techniques will not scale and provide inaccurate matches.

Broadly, an embodiment of the present disclosure provides a generative AI system that is private to the organizational entity not public and method for providing decision-support recommendations for meeting carbon and environmental impact goals. The generative AI utilizes private and domain specific large language models (LLM) that automate the identification, classification, and visualization of recommended alternatives materials through a recommendation engine. The recommendation engine uses generative AI techniques to train structured and unstructured data sources to identify alternative materials and alternative processes and energy sources. The private LLM is specifically trained and organized for the task of determining alternative low-carbon and environmentally friendly products, materials, processes and energy sources. The private LLM can be trained against the existing products, materials and chemicals. Once existing products, materials and chemicals have been profiled, the models are fed external data sources providing alternative recommendations. The private generative AI learns the alternatives and then creates a match of relationships between the current products, materials, components, suppliers and chemicals against the alternatives. This matching process ranks, classifies, and groups each existing material by every possible permutation, be it cost, supplier availability, sourcing, location, timelines, compatibility and environmental impacts (e.g., carbon emissions).

In operation, the private LLM generates an “Ecoscore” for any manufactured product or construction project. The Ecoscore is a single number that is derived from over 19+ environmental impact factors and that is unique for each product or material. Once the baseline Ecoscore has been calculated, the private LLM creates alternative Ecoscores, with lower environmental impacts. Product and material Ecoscores can then be assigned a blockchain token for provenance and potential trading on carbon exchanges. A user is presented with two outcomes: a intuitive knowledge graph where the user, on selecting the current material, is presented with alternative material recommendations to select from. These alternatives are ranked as “best fit” for intended usage. The second outcome is the prompt by the user—where the user can enter a request, for example, “find all the alternative materials for a Resin that are not made from petroleum”. The Generative AI model displays the options available to the user to select. The user's selections and interactions with the model recommendations are also captured as learning for future recommendations—i.e., a human in the loop to continuously feed the model.

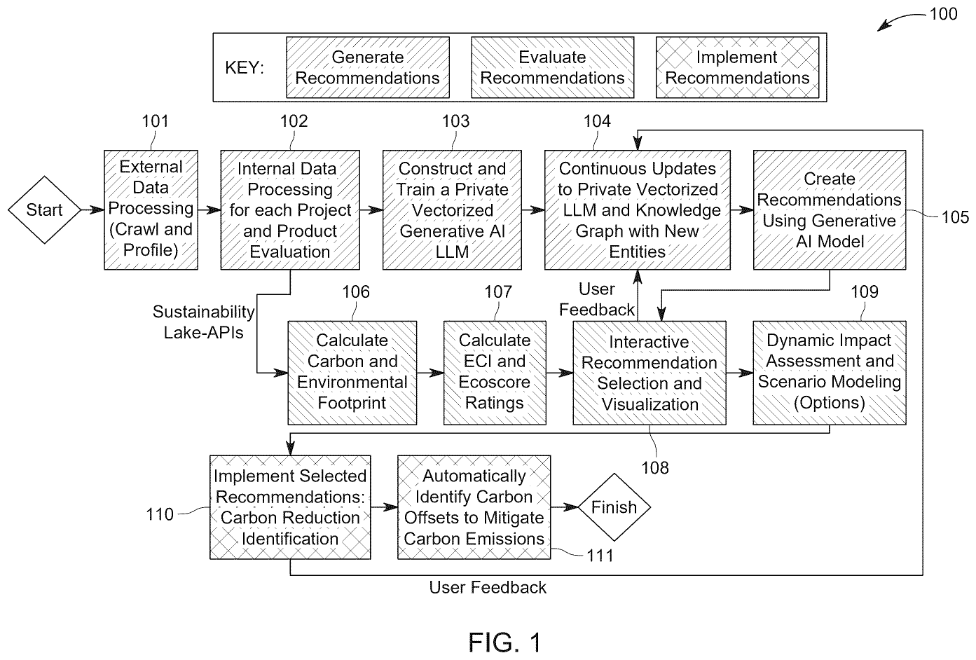

Referring now to FIG. 1, FIG. 1 illustrates an embodiment of a method 100 for providing recommendations through the use of Generative Artificial Intelligence techniques to create a private LLM. At step 101, a system can utilize a heterogeneous external (secondary) data acquisition framework to ingest and integrate diverse data types from one or more data sources, including structured, semi-structured, and unstructured formats, into one or more raw data sets in a data lake of the system for further processing. In an embodiment, this data can be categorized into three key domains: environmental regulations and standards, product information such as product declarations, and environmental data sets, and external databases such as chemical repositories. In an embodiment, the data can be one or more data sets related to one or more materials used in one or more projects and can include information such as, but not limited to, a unique identifier for a material, a material description, one or more environmental impacts, etc.

In an embodiment, the diverse data types can be ingested into the system using one or more crawlers that crawl the one or more data sources capturing relationships and semantics. Once ingested into the data lake of the system the one or more raw data sets can be further processed by the system to form one or more data levels in the data lake. In an embodiment, when information related to the one or more data sets cannot be determined, an exception or notification can be generated by the system to request/provide additional information, such as undetermined information, from one or more Subject Matter Experts (SME). Additionally, the one or more SMEs can validate and/or ensure accuracy of the one or more datasets.

Secondary Data Sets - Table 1 Environmental Standards

| Data Source | Description |
|---|---|
| Greenhouse Gas (GHG) Protocol | International standard for quantifying GHG emissions |
| Global Reporting Initiative (GRI) | Sustainability reporting standards |
| Sustainability Accounting Standards | Disclosure standards for 77 industries |
| Board (SASB) | |
| Taskforce on Climate-Related | Standard for climate-related financial disclosures |
| Disclosures (TCFD) | |
| The Taskforce on Nature-related | Reporting framework for nature-related financial risks and |
| Financial Disclosures (TNFD) | opportunities |
| Carbon Disclosure Project (CDP) | Environmental disclosure system for investors, companies, |
| | cities, states, and regions |
| Science Based Targets initiative | Guidelines for science-based emissions reduction targets |
| (SBTi) | |
| ISO 14040 | International standard for Life Cycle Assessment (LCA) |
| EU Green Deal Taxonomy | Classification system for financial investments |
| The Corporate Sustainability | EU sustainability reporting requirements for large companies |
| Reporting Directive (CSRD-ESRS) | |

As provided herein, Table 1 can be a non-limiting example of environmental regulations and standards that can be ingested at step 1.

Secondary Data Table 2 - Environmental Data Sources

| Internal Data Source | Description |
|---|---|
| Environmental Product Declarations | Manufactures environmental product declaration documents, |
| | in PDF format for materials supplied. |
| Safety Data Sheets | For any products/material consisting of hazardous |
| | chemicals, health risks, environmental risks. Usually |
| | provided in PDF format. |

As provided herein, Table 2 can be a non-limiting example of external products data sources that can be ingested at step 1.

Secondary Data Sources Table 3 - Environmental Emission Data Repositories

| External Data Source | | URL |
|---|---|---|
| 1. | Sphera (GaBi) | https://gabi.sphera.com/databases/ |
| 2. | Ecoinvent | https://ecoinvent.org/ |
| 3. | Envirodec EPD | https://environdec.com/library |
| 4. | UN IPCC | https://www.ipcc-nggip.iges.or.jp/EFDB/main.php |
| 5. | DEFRA | https://www.gov.uk/guidance/measuring-and-reporting- |
| | | environmental-impacts-guidance-for-businesses |
| 6. | Climate IQ | https://www.climatiq.io/ |
| 7. | ECI Eco Chain | https://ecochain.com/ |
| 8. | USEPA | https://edg.epa.gov/metadata/catalog/search/resource/details.pa |
| 9. | PubChem | https://pubchem.ncbi.nlm.nih.gov/sources/ |
| 10. | Bath University LCA | https://ghgprotocol.org/Third-Party-Databases/Bath-ICE |
| | embodied | |
| 11. | Sea-Route | https://pypi.org/project/searoute/ |
| 12. | Land-Route | https://www.liedman.net/leaflet-routing-machine/ |
| 13. | NERC | https://www.nerc.com/Pages/default.aspx |
| 14. | IEA | https://www.iea.org/about |
| 15. | Materials data | https://next-gen.materialsproject.org/ |
| 16. | Energy data connectivity | https://www.spglobal.com/commodityinsights/en/ci/solutions/energy- |
| | | data-connectivity/index.html |
| 17. | Social Hotspot (SHDB) | http://www.socialhotspot.org/purchase-shdb- |
| | | licences.html(http://www.socialhotspot.org/) |
| 18. | Vital metrics | https://vitalmetrics.com/environmental-databases |
| 19. | Google Earth Engine | https://code.earthengine.google.co.in/ |
| 20. | S&P Global | https://www.spglobal.com/commodityinsights/en/ci/solutions/energy- |
| | | data-connectivity/index.html |

As provided herein, Table 3 can be a non-limiting example of external source data sources that can be ingested at step 1.

At step 102, data can be processed on internally (primary) sourced data specific to a customer for each manufactured product configuration or construction project evaluation. In an embodiment, the internally processed data can be data incorporated from customer systems (CAD, ERP, SCM, PLM, etc.) via extractions or APIs of the system into one or more raw data sets for further processing. In an embodiment, internally sourced data can be ingested and processed similar to, or the same as, external data in step 101, ultimately landing in the data lake of the system. Table 4 illustrates non-limiting examples of data that can be acquired from customer systems.

Primary Data Sources -Table 4: Customer Data Systems

| Internal Data Source | URL |
|---|---|
| Bill of Materials (BOM) | Detailed breakdown of the materials, quantities, supplier ID |
| | and descriptions used to manufacture a product or construct |
| | a project. Usually provided as multi-tiered CSV file or an |
| | API to ERP system |
| Building Information Management | Detailed breakdown of the design configuration, materials, |
| (BIM) | layout and structures and systems within the building |
| | design. Usually provided as a BIM XML file, API or CSV/ |
| | MS Excel from CAD systems. |
| Suppliers | For all materials, list of final suppliers including distributors |
| | and location addresses. Classify by Tier 1, Tier 2 and Tier 3, |
| | Tier 4 supplier, if available. Usually provided as a CSV file |
| | or API with the Bill of Materials. |
| Environmental Product Declarations | Manufactures environmental product declaration |
| | documents, in PDF format for materials supplied. |
| Safety Data Sheets | For any products/material consisting of hazardous |
| | chemicals, health risks, environmental risks. Usually |
| | provided in PDF format. |
| Energy Data | Data from energy systems, BMS systems, utility provided |
| | data or energy billings by date, type of energy, location/area |
| | and facilities. |
| Transportation and Logistics | Modes of transportation used to carry product, materials, |
| | excavation tools/methods, capacity and fuel consumption. |
| MES, SCADA or Industrial Systems | Real-time data from manufacturing processes stored in MES |
| | (Manufacturing Execution Systems) or SCADA systems |
| | providing details on material usage, energy use, machinery |
| | and operation of complex industrial systems such as a |
| | Cement Klin or Steel Furnace. |

At step 103, a custom vectorized private and domain specific Generative AI Large Language Model (LLM), stored in a Graph database tailored for sustainable material discovery and recommendation can be constructed and trained. The private and domain specific LLM can reside within a high-dimensional feature space and can leverage a multi-relational knowledge graph of material and chemical relationships. The knowledge graph can allow the private LLM to perform vector-based reasoning, enabling it to efficiently navigate the complex landscape of material and chemical options and identify the most suitable alternatives for any given application.

At step 103, the private LLM can undergo training, which can be guided by a custom created objective function. The objective function can prioritize the generation of relevant and feasible alternative materials by balancing trade-offs between cost, performance, time, interdependencies and environmental impact. Specific penalty terms or multi-objective optimization strategies can be employed within the objective function to balance these trade-offs providing an input into Marginal Abatement Cost curves.

At step 104, the custom vectorized private LLM and knowledge graph can be continuously updated with new external and internal data sets through an automated data integration pipeline. This pipeline can ensure seamless ingestion, processing, and integration of new data. For example, new material and chemical properties can be incorporated into the knowledge graph, which can expand the scope and enable more comprehensive comparisons and recommendations. Furthermore, newly discovered or emerging alternative materials and their relationships with existing options can be added to the knowledge graph, which can enhance the private LLM's ability to identify optimal solutions. Finally, user interactions with the system, including selections, queries, and feedback, can be captured, and analyzed which can personalize future recommendations. The above data can inform the private LLM's internal models and objective functions, which can lead to more tailored and relevant suggestions over time. The dynamic update process can ensure that the private LLM and knowledge graph remain current, adaptable, and capable of providing accurate and personalized recommendations for alternative materials and chemicals based on the latest information and user preferences.

At step 105, building upon the updated knowledge graph and vector representations acquired in Step 104, this step can leverage the generative AI model to generate personalized, actionable recommendations for reducing the environmental impact of a specific construction project or a manufactured product under evaluation. These recommendations can be dynamically tailored to the user's preferences, project context, and the latest data available in the knowledge graph. Furthermore, leveraging the knowledge graph and vector representations generated in Step 103, Step 105 can generate customized recommendations for the specific construction project or product under evaluation from Step 104. Table 5 illustrates non-limiting examples of recommendations that can be provided by the private and domain specific Generative AI.

Environment Abatement Strategies - Table 5

| | Net-zero | | | |
|---|---|---|---|---|
| | decarbonization | Recommendation | | Impact |
| # | Strategy | Category | | Focus |
| 1 | Avoidance at | a. | Substitution for high-carbon materials: | Reduced embodied |
| | Design | | Identify and recommend alternative materials | carbon |
| | | | with lower carbon footprints. | |
| | | b. | Sustainable supply chains: Analyze and | Reduced operational |
| | | | optimize supply chains to reduce environmental | emissions |
| | | | impact and resource consumption. | |
| 2 | Energy | c. | Energy efficiency measures: Identify and | Reduced operational |
| | Efficiency | | suggest strategies to improve energy efficiency | emissions |
| | | | in production, operation, or maintenance. | |
| 3 | Alternative | d. | Transition to renewable energy sources: | Reduced operational |
| | Energy | | Evaluate and recommend feasible options for | emissions |
| | | | switching to renewable energy sources. | |
| 4 | Carbon Capture | e. | Carbon capture technologies: Explore and | Direct emissions |
| | | | assess the potential of implementing carbon | reduction |
| | | | capture technologies for emissions reduction. | |
| 5 | Environmental | f. | Eliminate harmful chemicals: Identify and | Reduced environmental |
| | Restoration | | phase out the use of harmful chemicals in | impact |
| | | | processes and materials. | |
| | | g. | Greenery planting & conservation: Develop | Carbon sequestration, |
| | | | plans for planting and conserving native | environmental |
| | | | vegetation to improve air quality and | restoration |
| | | | biodiversity. | |
| | | h. | Mangrove protection & restoration: Support | Carbon sequestration, |
| | | | initiatives to protect and restore critical | coastal protection |
| | | | mangrove ecosystems. | |
| | | i. | Wetland restoration: Implement wetland | Carbon sequestration, |
| | | | restoration projects to improve water quality and | water quality |
| | | | ecological balance. | improvement |
| | | j. | Sustainable agriculture practices: Promote | Reduced supply chain |
| | | | and encourage the adoption of sustainable | emissions |
| | | | agricultural practices to reduce environmental | |
| | | | impact. | |
| | | k. | Biological capture sequestration: Explore and | Carbon sequestration, |
| | | | assess the potential of using biological methods | natural resource |
| | | | for carbon capture and sequestration. | restoration |
| | | l. | Reforestation: Support reforestation efforts to | Carbon sequestration, |
| | | | restore forests and combat climate change. | natural resource |
| | | | | restoration |

At step 106, an environmental impact can be assessed based on the data collected and processed for the design project or product in Step 102, the baseline carbon footprint, and any options. A total of nineteen (19) environmental impact metrics can be calculated, which can provide a comprehensive understanding of the chosen solution's sustainability profile. Table 6 illustrates non-limiting examples of the calculated metrics.

Environmental Impacts - Table 6

| Impact Category | | Unit | |
|---|---|---|---|
| 1. | Climate Change - | kg CO2- | Greenhouse gas emissions from all sources, |
| | Total (GWP) | eq | including fossil fuels, biogenic materials, and land |
| | | | use change. |
| 2. | Climate Change - | kg CO2- | Emissions from fossil fuels such as coal, oil, and |
| | Fossil | eq | natural gas. |
| 3. | Climate Change - | kg CO2- | Emissions from the use or decomposition of |
| | Biogenic | eq | organic materials like wood or biomass. |
| 4. | Climate Change - | kg CO2- | Emissions associated with land use changes like |
| | land use and change | eq | deforestation or agricultural expansion. |
| | to land use | | |
| 5. | Abiotic Depletion - | MJ, net | Consumption of non-renewable fossil fuel |
| | Fuel | cal. Val. | resources. |
| 6. | Abiotic Depletion - | Kg Sb eq | Consumption of non-renewable mineral resources |
| | Nonfuel | | like metals and minerals. |
| 7. | Ozone Layer | kg | Potential for depleting the ozone layer through |
| | Depletion (ODP) | CFC11- | emissions of harmful chemicals. |
| | | eq | |
| 8. | Petrochemical | Kg | Formation of harmful air pollutants from the |
| | Oxidation | NMVOC- | oxidation of volatile organic compounds. |
| | | eq | |
| 9. | Acidification | mol H+- | Contribution to acidification of air and water |
| | | eq | bodies. |
| 10. | Eutrophication | Kg N-eq | Nutrient enrichment of water bodies leading to |
| | | | algal blooms and ecosystem disruption. |
| 11. | Human Toxicity | CTUh | Potential for causing harm to human health |
| | | | through exposure to toxic substances. |
| 12. | Water Use | M3 world | Consumption of freshwater resources. |
| | | eq | |
| 13. | Fine Particulate | Illness | Potential for causing respiratory illnesses due to |
| | Emissions | incidence | exposure to fine particulate matter. |
| 14. | Ionizing Radiation | kBq | Potential exposure to ionizing radiation. |
| | | U235-eq | |
| 15. | Aquatic Ecotoxicity - | CTUe | Potential for harming aquatic ecosystems through |
| | Freshwater | | pollution or habitat disruption. |
| 16. | Aquatic Ecotoxicity - | CTUe | Potential for harming marine ecosystems through |
| | Marine | | sediment contamination. |
| 17. | Terrestric | CTUe | Potential for harming terrestrial ecosystems |
| | Ecotoxicity | | through pollution or habitat disruption. |
| 18. | Freshwater Sediment | kg PO4- | Potential for harming freshwater ecosystems |
| | Ecotoxicity | eq | through sediment contamination. |
| 19. | Marine Sediment | CTUe | Potential for harming marine ecosystems through |
| | Ecotoxicity | | sediment contamination. |

The calculated impact metrics can be presented to the user in a clear and intuitive format, such as interactive charts or dashboards. Advantageously, the presentation allows for assessing the environmental impact of the chosen solution relative to the baseline scenario (as-is design) and alternative recommendations; identifying key areas where the chosen solution contributes the most to environmental impacts, enabling targeted optimization efforts; and empowering users to make informed choices, leveraging marginal abatement cost curve visualizations based on the comprehensive understanding of their project's environmental footprint.

At step 107, the private and domain specific Generative AI methods allow for an environmental cost indicator (ECI) and an Ecoscore to be calculated. The ECI can aggregate and normalize impact metrics across all environmental categories into a single, financial-equivalent cost, which represents the societal cost associated with the environmental burden of the project or product throughout its lifecycle. The ECI can be aggregated across different levels, such as individual projects, company-wide portfolios, or even national economic analyses. Advantageously, ECI can facilitate informed decision-making by enabling straightforward comparison of design options and highlighting hidden environmental costs in an apples-to-apples manner. An Ecoscore can provide a graded rating system for both individual environmental impact categories and the overall project performance. The individual Ecoscore can be calculated for each impact category in Table 6 (e.g., Climate Change, Ozone Depletion), normalized within the expected range for each consumer product category (e.g., furniture, electronics), and converted to a letter grade (e.g., AAA, AA, A, B) for clear communication. An overall Ecoscore can represent a single, normalized score (0-50) based on the weighted average of individual category Ecoscores. Advantageously, the overall Ecoscore can provide a holistic and easily comparable measure of the product's or project's overall environmental performance. Furthermore, the Ecoscore can promote transparency and simplifies communication of environmental impact, enabling comparison and discussion among stakeholders with varying technical backgrounds. To provide confidence and integrity of the data and the calculation of the Ecoscore, the data will be stored in a Blockchain ledger, and a blockchain token can be associated with any Ecoscore. Furthermore, the Ecoscore blockchain token can be converted into a secure QR code, ensuring the authenticity and provenance of the Ecoscore, allowing for integration into Carbon trading and consumer gamification applications.

At step 108, the private and domain specific generative AI model recommendation engine can generate customized recommendations to replace high carbon, and other impactful materials, with alternatives to reduce the environmental impact of the specific construction project or product under evaluation. For each recommendation, the engine can provide an estimate of the required investment and potential funding options, including government grants, climate technology investments, or carbon credit purchases. These recommendations can be shown visually. In an embodiment, the visual display can be a dynamic bubble chart and marginal abatement cost curve, where the bar chart and bubble size reflect the estimated impact and the financial investment to achieve carbon reduction. Visualization can allow users to easily compare and prioritize different options from a climate and financial performance perspective based on their specific needs and preferences. Furthermore, the private and domain specific Generative AI can leverage the user's interactions with the recommendations to personalize future suggestions. By analyzing user selections, feedback, and exploration patterns within the knowledge graph, the generative AI model can refine its understanding of individual priorities and tailor future recommendations for greater efficacy and user satisfaction. This user-centric approach fosters informed decision-making and empowers users to actively contribute to the optimization of their design's environmental performance from a climate and financial perspective.

At step 109, the private Generative AI model generated ECI and Ecoscore results generated can be updated for each option being considered by the user in Step 108. The user can model multiple scenarios, alternatives and simulate options to reduce the total environmental impact of a product or service. As users explore and interact with recommended options in Step 108, the model can recalculate and present the corresponding ECI and Ecoscore values in real-time. This provides immediate feedback on the environmental implications of chosen alternatives. Users can define and simulate various design scenarios by specifying targeted modifications in material choices, manufacturing processes, or specific design features, or meet organizational and governmental net-zero design goals. The private Generative AI model can then calculate the resulting ECI and Ecoscore for each scenario, allowing for comprehensive evaluations of different optimization strategies. Users can analyze the impact of their chosen scenarios across individual environmental impact categories within the ECI framework, which can enable focused identification of key impact contributors and optimal reduction strategies. Users can discover design solutions that meet their project's specific priorities, financial metrics and constraints by simulating scenarios that balance environmental impact with other crucial factors like cost and performance.

At step 110, a user can finalize a decision by selecting the preferred option, from options modeled and assessed in step 109, which can transition the option from theoretical exploration into concrete implementation within the product development or project design process. The chosen option can automatically be categorized as a “NetZero Carbon Reduction Strategy” based on its impact calculations within the private Generative AI driven ECI and Ecoscore framework. The classification can quantify the environmental benefit associated with the chosen design modifications. The chosen option and decisions taken by the user are automatically fed back into Step 103 above to improve the learning and quality of the future recommendations. The system can integrate with blockchain technology by assigning a unique and immutable key to the validated carbon reduction generated by the chosen option. The blockchain token can serve as a permanent record of the achieved environmental benefit, which can enable users to confidently showcase their sustainability efforts to stakeholders and trade the token into the broader carbon offset crypto market.

At Step 111, the private and domain specific Generative AI model can be extended to automatically identify carbon offset assets across multiple carbon offset exchanges and the user can select the optimum carbon offset strategy, based on selection made in step 110. A carbon reduction, or company generated offset, can be automatically identified, along with the associated carbon offset asset class and registry to offer the reduction against and which voluntary carbon market exchange. A Multi-Carbon Offset Exchange Asset Search module can automatically scour data from multiple carbon exchanges, identifying verified offset assets that match the user's project or product requirements to offset Carbon Emissions. This comprehensive private and domain specific Generative AI driven search ensures users have access to the most diverse and competitive pool of carbon offset options. Each offset, identified by the Generative AI enabled search module, can be evaluated based on three critical factors: quality (registry, project type), price competitiveness, and projected return on the offset investment. This multi-dimensional analysis ensures users select offsets that deliver both immediate impact and long-term environmental benefits. Using advanced AI algorithms, the system can precisely match the identified and validated carbon emissions with suitable offset options within the carbon exchange environment. This matching process can consider user-defined constraints, which can ensure an optimum fit between emission reduction needs and available carbon offsets. Finally, the Generative AI enabled search module can leverage the matching results to select the most advantageous offset strategy for the user. This selection can consider the quality, price, and ROI profiles of individual offsets, as well as project-specific considerations, to deliver the most impactful and cost-effective solution.

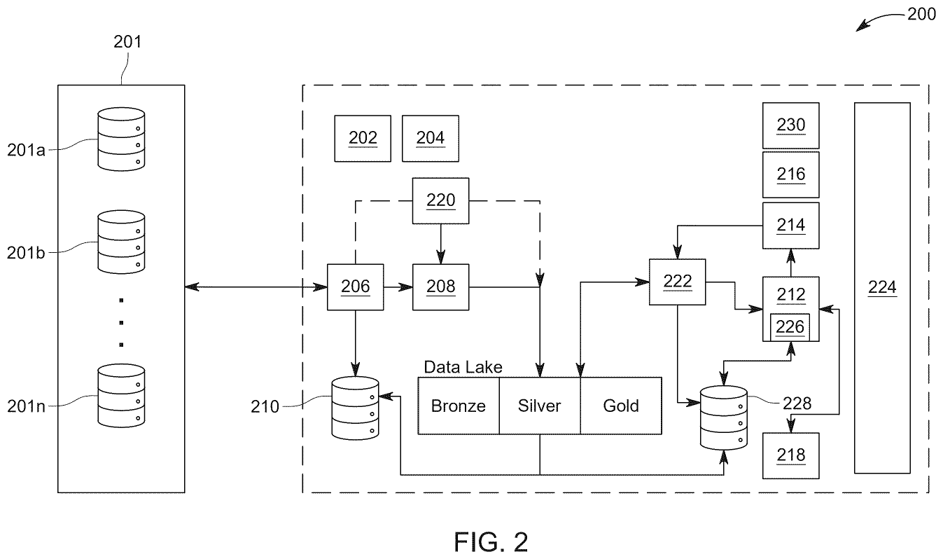

Referring now to FIG. 2, FIG. 2 illustrates an embodiment of a private and domain specific Generative AI system 200 for identifying and recommending environmentally conscious alternative materials, components and parts for construction projects and manufactured products. The private and domain specific Generative AI system 200 includes at least one processor 202, at least one memory 204, a data acquisition and profiling module 206, a data ingestion and processing module 208, an active metadata repository 210, a private and domain specific generative AI LLM 212, a recommendation generation engine 214, a generative AI driven carbon and environmental footprint calculator 216, a dependency registry and validation module 218, a human supervision and quality control module 220, a continuous learning module 222, at least one user interface 224, a blockchain module 226, a graph database 228 and/or a carbon offset identification module 230. In embodiments, the private and domain specific Generative AI system 200 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

The private and domain specific Generative AI system 200 includes at least one processor 202 to perform various computational and data processing tasks, as well as other functionality. The at least one processor 202 is in communication with the at least one memory 204. In some embodiments, the at least one memory 204 comprises one or more computer readable storage media with program instructions collectively stored on the one or more computer readable storage media, with the program instructions being executable by the at least one processor 202 to cause the at least one processor 202 to perform operations described herein.

In an embodiment, the data acquisition and profiling module 206 can be configured to acquire and analyze at least one data from at least one data source. In an embodiment, data acquisition, by the data acquisition and profiling module 206, can include one or more crawlers, spiders, extractors, and/or scrapers, configured to automatically retrieve one or more datasets from one or more external, and/or internal data sources. In an embodiment, data profiling module 206 can perform, or assist in the performance of one or more steps of method 100, such as steps 101-102, and functions as described therewith.

In an embodiment, the one or more datasets and/or the one or more external and/or internal data sources can be homogenous and/or heterogeneous from primary or secondary data sources. In an embodiment, the one or more datasets upon acquisition, by the data acquisition and profiling module 206, can be acquired as raw data in any format, such as structured, semi-structured, and/or unstructured. In an embodiment, the one or more datasets, can be stored initially in one or more raw data formats in one or more data lakes of system 200. In an embodiment, the one or more data lakes can include a plurality of landing zones, configured to store, process, and/or curate the one or more datasets, described further hereinafter.

In an embodiment, the data acquisition and profiling module 206 can be configured to profile the one or more datasets upon acquisition. In an embodiment, profiling can include extracting one or more metadata associated with the one or more datasets for storage into the active metadata repository 210, described further hereinafter. In an embodiment, the one or more metadata can include, but is not limited to, one or more files, one or more connections, one or more volumes, and/or one or more timestamps, associated with the one or more datasets. In an exemplary embodiment, profiling can extract metadata from the one or more datasets to track what, when, where, and/or how the one or more datasets were ingested by the system.

In an embodiment, the data ingestion and processing module 208 can be configured to ingest and process the at least one data from the at least one data source to curate and refine the at least one data into one or more usable data products. In an embodiment, the data ingestion and processing module can ingest one or more datasets stored in the one or more data lakes, in their own native format, and process the one or more datasets into one or more landing zones of the one or more data lakes. In an embodiment, the one or more landing zones can process the one or more datasets in accordance with one or more requirements of the one or more landing zones. In an exemplary embodiment, the one or more data lakes can have at least three landing zones, bronze, silver, and gold, using one or more functions of the data ingestions and processing module 208 to refine, curate, standardize, harmonize, and/or otherwise process the one or more datasets (as defined in primary and secondary datasets). In an embodiment, data profiling ingestion and processing module 208 can perform, or assist in the performance of one or more steps of method 100, such as steps 101-102, and functions as described therewith.

In an embodiment, the data ingestion and processing module 208 can be configured, in the bronze zone, to store the one or more datasets, in their raw form. Additionally, the data ingestion and processing module 208 can, in the bronze zone, be configured to profile the one or more datasets and to perform metadata extraction on the one or more datasets, such that metadata is extracted to active metadata repository 210 and associated with the one or more datasets from which it was extracted. Profiling data sets can include but not be limited to identifying null, duplicate or previously processed data, dependencies and relationships of tables and data sets.

In an embodiment, the data ingestion and processing module 208 can be configured, in the silver zone, to transform the one or more datasets to define one or more data products. In an embodiment, transformation of the one or more datasets can include one or more functions to transform the one or more datasets through one or more data pipelines, extract one or more business metadata from the one or more datasets, harmonize, standardize, or otherwise normalize, the one or more datasets, and/or apply one or more business logic functions to transform the one or more datasets to data products. An example of standardization can include but not be limited to, applying standard unit of measures to material volumes, for instance converting from grams to Kilograms (KGs). Additionally, the data ingestion and processing module 208 can, in the silver zone, be configured to profile to validate the one or more data products. In an embodiment, validation can occur using one or more human SME validating the one or more data products. It is understood that the one or more datasets can refer to all, or a subset of the one or more datasets provided to the bronze zone.

In an embodiment, the data ingestion and processing module 208 can be configured, in the gold zone, to ingest and/or otherwise load the one or more data products into a graph database 228 of system 200. In an embodiment, the data ingestion and processing module 208 can be configured, in the gold zone, to ensure that all data products are uniquely identified, i.e. perform deduplication, and stored with associated metadata, such as activity names, reference products, and environmental impact metrics. Additionally, the data ingestion and processing module 208 can be configured, in the gold zone, to transform, clean, translate, and/or modify the one or more environmental specific data products to meet the required format of the graph database 228.

In an embodiment, graph database 228 can be a knowledge graph database configured to store the one or more data products in a structured manner. In an embodiment, the one or more data products can be a comprehensive knowledge graph of material and chemical relationships. In an embodiment, one or more nodes of graph database 228 can represent an entity of the one or more data products and an edge between the one or more nodes of graph database 228 can represent a relationship between the one or more nodes that it connects. In an embodiment, graph database 228, and/or data ingestion and processing module 208, can include functionality to pre-process the one or more data products such that each node and edge of graph database 228 is initialized with a signature, or feature vector, computed taking into account all information of each node. In an embodiment, the signature, or feature vector, for each node can be stored in a vector index of graph database 228. Advantageously, graph database 228 along with the vector index can be configured to quickly and efficiently discover answers to questions.

In an embodiment, a private and domain specific generative AI large language model (LLM) 212 which is trained on using graph database 228 and configured to generate one or more personalized, actionable recommendations for reducing environmental impact of one or more items under evaluation, utilizing including at least one dependency, and advanced vector-based reasoning. In an embodiment, LLM 212 resides in high-dimensional feature space and leverages graph database 228 to perform vector-based reasoning. In an embodiment, training of LLM 212 utilizes an objective function that prioritizes generation of relevant and feasible alternative data products, such as materials, by balancing trade-offs between costs, performance, time, risk and environmental impact. In an embodiment, one or more penalty terms, or multi-objective optimization strategies are employed with the objective function to achieve trade-off balance. In an embodiment, LLM 212 can be trained and continuously updated as reference in method 100, such as in steps 103-104, 108 and 110.

In an embodiment, a recommendation generation engine 214, powered by the private and domain specific LLM 212 and graph database 228, can be configured to analyze at least one application requirement and identify at least one suitable alternative based on the at least one application requirement. In an embodiment, recommendation generation engine 214 can be a generative AI, such as a generative transformer, that leverages LLM 212 to generate one or more customized recommendations to a user of system 200. In an exemplary embodiment, recommendation generation engine 214 can generate one or more recommendations in accordance with step 5 of method 100. The LLM 212 encompasses relationships, interdependencies and strength of similarities across primary and secondary data sets, enabling the Generative AI LLM engine the ability to automatically classify, group and sort baseline materials (current design) with alternatives that may be the best-fit to replace the incumbent material with lower environmental impact materials, energy or process. The underlying functionality to enable the semantic matching uses Graph databases to store node properties and relationship as the foundational data store. Through the use of embeddings and vectorization technologies combined with RAG (Retrieval Augmented Generation), the Generative LLM engine allows valuable insights from complex data structures, facilitating informed and contextualized matching of material alternatives and substitutes. In an embodiment, recommendation generation engine 214 can capture one or more user interactions therewith to improve future recommendations.

In an embodiment, a generative AI driven carbon and environmental footprint calculator 216 can be configured to calculate an Environmental Cost Indicator (ECI) and a weighted Ecoscore, representing both an individual environmental impact for categories and an overall performance. In an embodiment, the ECI and weighted Ecoscore can be calculated in accordance with step 106-107 of method 100. Through the automatic identification of material descriptions, the generative AI driven carbon and environmental footprint calculator 216 finds and calculates the environmental impacts (using secondary data sets) and determines the ECI and Ecoscore based on the sub-material composition, processes, energy and transportation routes. The ECI is based on the summation of multiple factors, such as the material cost (purchase), the energy usage, the production processes and assignment of carbon cost and other cost environmental factors, such as human toxicity to each subcomponent of the product structure. Once the ECI (or the societal cost of the product and subcomponents) has been calculated, a normalization algorithm is applied, applying a weighting to each component and rolling-up to the product level. The weightings range from 1 to 5 is assigned, although this is configurable, where 1 represents the lowest environmental impact and 5 the highest environmental impact. As these weightings for all components of a product, a range is created to group individual components into classifications, for example all weightings within the range 0.01 to 1.0, are assigned triple AAA rating, similar to how credit ratings are assigned to investments. These ratings represent the EcoScore (i.e. AAA, AAB, etc.) are applied to every component and the product to indicate visually the environmental impact of the product to society.

In an embodiment, a dependency registry and validation module 218 can be configured to maintain and validate dependencies identified by the private and domain specific LLM 212. In an embodiment, LLM 212 can identify one or more dependencies during traversal, search, training, or other processing of graph database 228. An example, the ability to identify “valid” alternatives to replace high carbon content materials with low carbon alternatives, requires the ability to ensure alternative recommendations can be feasible from scientific, manufacturing or process perspective through dependency validation. Furthermore, the ability to visualize alternatives that have similar material attributes but with lower environmental impacts is realized leveraging the dependency registry. In an embodiment, dependency registry and validation module 218 can create a data structure, such as a map, index, etc., of the one or more dependencies. In an embodiment, dependency registry and validation module 218 can utilize the data structure to detect anomalies in LLM 212, thereby allowing system 200 to identify and address inconsistencies, inaccurate associations, etc., of LLM 212. Advantageously, dependency registry and validation module 218 can be utilized to guarantee accuracy and completeness of LLM 212.

In an embodiment, a human supervision and quality control module 220 can be configured to apply at least one rule, the at least one rule pertaining to quality, security, and/or ethics. In an embodiment, human supervision and quality control module 220 can provide the at least one rule to data ingestion and processing module 208, and/or operate in place thereof, to validate the one or more data sets in silver zone. In an embodiment, one or more human reviewers can apply one or more domain specific rules to one or more data items such that data quality, security, explainability, privacy and/or ethics of one or more recommendations of LLM 212 are reliable and unbiased.

In an embodiment a continuous learning module 222 can be configured to dynamically update and refresh the private and domain specific LLM 212 and graph database 228 based on changes in the data sources and at least one interaction from user input and selections, such as from recommendation generation engine 214. An example of continuous learning would be the publication of updated environmental factors from secondary data sources to enrich and update the private and domain specific LLM and graph database. In an embodiment, LLM 212 and graph database 228 can be continuously updated with new datasets such as new internal, and/or external datasets. In an exemplary embodiment, new material and/or chemical properties can be ingested, as described above, into graph database 228, which can lead to newly discovered and/or emerging alternative materials and relationships with existing datasets which can be added to graph database 228, thereby enhancing LLM 212 ability to identify solutions. Additionally, one or more user interactions with system 200, such as selections of items, recommendations, etc., queries and/or additional feedback, can be captured by continuous learning module 222 and analyzed for improved future recommendation.

In an embodiment, at least one user interface 224 can be configured to interact with a plurality of modules, and/or sub-modules to present one or more data items to the user of system 200. In an embodiment, at least one user interface 224 can enable a user to explore and select at least one data item, such as a node, or edge, within a dynamic knowledge graph generated and embedded visualizations using graph database 228 and LLM 212, visualize the at least one data item, present a ranked set of related alternatives based the at least one option, navigate the dynamic knowledge graph through user-driven filtering and exploration, and/or simulate the impact of at least one option on the ECI and Ecoscore ratings.

In an embodiment, at least one user interface 224 can access a query module configured to query graph database 228. In an embodiment, at least one query, which an be one or more user questions, such as natural language questions, can be provided to the query module through at least one user interface 224. In an embodiment, query module can perform one or more LLM embeddings on the at least one query, by transforming the at least one query into a feature vector, or signature, that encodes one or more semantic meaning(s) from the at least one query thereby enabling similarity searches and advanced queries. In an embodiment, query module can include a Natural Language Processor submodule configured to assist in transforming the at least one query for LLM embedding.

In an embodiment, the feature vector, or signature, can be utilized by the query module to search the vector index for one or more results, i.e. an initial set of results. In an embodiments, the one or more results are initial implicit results. In an embodiment, the one or more initial implicit results can be utilized by LLM 212 to search graph database 228. In an embodiment, LLM 212 in concert with query module can perform one or more additional queries, to extract one or more explicit results, i.e. answers that directly address the query and draw upon the context offered by graph database 228. In an embodiment, the one or more results can be merged with the one or more explicit results to form one or more final results to provide a more comprehensive understanding of the query. In an embodiment, LLM 212 armed with the one or more final results can formulate a natural language response using the Natural Language Processor submodule. In an embodiment, the one or more final results can include one or more items from graph database 228, and/or one or more actionable alternatives, recommendations, best practices, and/or relevant resources. In an embodiment, query module can be a part of LLM 212 and/or a separate module.

In an embodiment, the at least one user interface 224 can include one or more interfaces configured for visual exploration of graph database 228. In an embodiment, one or more portions of graph database 228 can be displayed in response to the query. For example, a current material for a project may be displayed along with a ranked set of alternatives based on one or more factors, such as suitability, environmental impact, cost, risk, timeline etc., which a user can navigate.

In an embodiment a blockchain module 226 can be configured to record one or more items to the blockchain ledger. In an embodiment, the one or more items can include one or more validated projects, products, emissions, reductions, and/or solutions provided by system 200. The blockchain ledger entries provide immutable evidence of the underlying environmental and carbon emission data, calculations, changes and access; thereby providing evidence on the integrity of the data that can be proven in a court of law. Furthermore, the use of Blockchain allows for the allocation of a non fungible token to be associated with the Ecoscore, for example a laptop with an Ecoscore has a token which guarantees to the consumer the integrity of the underlying data sources and also allows for comparison and monetization of Ecoscore tokens on a marketplace.

In an embodiment, a carbon offset identification module 230 can be configured identify one or more carbon offsets. In an embodiment, system 200 can provide one or more responses, recommendations, materials, etc., which may include one or more environmental impacts, such as carbon emissions. In an embodiment, carbon offset identification module 230 can identify at least one carbon offset assets; match at least one identified and validated carbon emissions to the at least one carbon offset within a carbon exchange; and select an optimum carbon offset strategy based on the match.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM) or Flash memory, a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

What is claimed is:

1. A private and domain specific Generative AI system for identifying and recommending environmentally conscious alternative materials, components, energy and parts for construction projects and manufactured products, comprising:
a data acquisition and profiling module for acquiring and analyzing at least one data from at least one data source;
a data ingestion and processing module for ingesting and processing the at least one data from the at least one data source;
an active metadata repository for maintaining at least one metadata associated with the at least one data;
a private and domain specific generative AI large language model (LLM), wherein the LLM is trained on a comprehensive knowledge graph of material and chemical relationships, including at least one dependency, and utilizes advanced vector-based reasoning;
a recommendation generation engine, powered by the private and domain specific LLM and knowledge graph, for analyzing at least one application requirement and for identifying at least one suitable alternative based on the at least one application requirement;
a generative AI driven carbon and environmental footprint calculator for calculating an Environmental Cost Indicator (ECI) and a weighted Ecoscore;
a dependency registry and validation module for maintaining and validating the at least one dependency identified by the private and domain specific LLM; and
a human supervision and quality control module for applying at least one rule, the at least one rule pertaining to quality, security, and/or ethics.

2. The Generative AI system of claim 1, further comprising:
a continuous learning module configured to dynamically update and refresh the private and domain specific LLM and the knowledge graph based on changes in the data sources and at least one interaction from user input and selections.

3. The private Generative AI system of claim 1, further comprising:
a user interface configured to:
enable a user to explore and select at least one option within a dynamic knowledge graph;
visualize the at least one option;
present a ranked set of related alternatives based the at least one option;
navigate the dynamic knowledge graph through user-driven filtering and exploration;
simulate the impact of at least one option on the ECI and Ecoscore ratings.

4. The private Generative AI system of claim 2, wherein the Generative AI system utilizes at least one interaction and at least one recommendation to retrain the LLM.

5. The private Generative AI system of claim 1, further comprising:
a blockchain module configured to record validated projects, products, emissions and reductions on a blockchain ledger and generation of a blockchain token.

6. The private Generative AI system of claim 1, further comprising:
A carbon offset identification module configured to:
identify at least one carbon offset assets;
match at least one identified and validated carbon emissions to the at least one carbon offset within a carbon exchange; and
select an optimum carbon offset strategy based on the match.

7. A method for generating environmentally conscious alternatives for construction projects and products, comprising:
acquiring and processing at least one of: external and internal data;
training a private vectorized generative AI large language model (LLM) on the processed data;
generating at least one recommendation for alternative materials and chemicals using the LLM;
calculating a carbon and an environmental footprint for a project or product;
generating an Environmental Cost Indicator (ECI) and a weighted Ecoscore based on the calculated carbon and the environmental footprint;
presenting the at least one recommendation to a user;
Enabling a user to select and visualize at least one option, wherein the option is presented based on the at least one recommendation;
simulating an impact of the at least one option on the ECI and the Ecoscore;
recording at least one validated carbon emissions and reductions on a blockchain ledger; and
identifying carbon offset assets based on the at least one validated carbon emission and reductions.

8. A non-transitory computer-readable storage medium storing instructions that, when executed by a computer, cause the computer to perform the method of claim 7.

9. A non-transitory computer-readable medium storing a private and domain specific vectorized generative AI large language model (LLM) trained on a dataset of environmental regulations, product information, and external databases, and capable of generating recommendations for alternative materials and chemicals for construction projects and manufactured products.
